(19) United States
(12) Patent Application Publication
(10) Pub. No.: US 2020/0152361 A1
(43) Pub. Date: May 14, 2020

(54) RESISTOR WITH UPPER SURFACE HEAT DISSIPATION

(71) Applicant: Vishay Dale Electronics, LLC, Columbus, NE (US)

(72) Inventors: Todd L. Wyatt, Columbus, NE (US); Darin W. Glenn, Columbus, NE (US)

(73) Assignee: Vishay Dale Electronics, LLC, Columbus, NE (US)

(21) Appl. No.: 16/594,775

(22) Filed: Oct. 7, 2019

Related U.S. Application Data
(63) Continuation of application No. 16/181,006, filed on Nov. 5, 2018, now Pat. No. 10,438,729.
(60) Provisional application No. 62/584,505, filed on Nov. 10, 2017.

(51) Int. Cl. H01C 1/084; H01C 1/034; H01C 1/01; H01C 17/28; H01C 17/02; H01C 1/148

(52) U.S. Cl. CPC H01C 1/084; H01C 1/034; H01C 1/01; C22C 9/00; H01C 17/02; H01C 1/148; H01C 17/28

(57) ABSTRACT

Resistors and a method of manufacturing resistors are described herein. A resistor includes a resistive element and a plurality of upper heat dissipation elements. The plurality of heat dissipation elements are electrically insulated from one another via a dielectric material and thermally coupled to the resistive element via an adhesive material disposed between each of the plurality of heat dissipation elements and a surface of the resistive element. Electrode layers are provided on a bottom surface of the resistive element. Solderable layers form side surfaces of the resistor and assist in thermally coupling the heat dissipation elements, the resistor and the electrode layers.

### CROSS REFERENCE TO RELATED APPLICATION(S)

This application is a continuation of U.S. patent application Ser. No. 16/181,006, filed Nov. 5, 2018, which claims the benefit of U.S. Provisional Application Ser. No. 62/584,505, filed Nov. 10, 2017, which are incorporated by reference in their entireties as if fully set forth herein.

### FIELD OF INVENTION

This application relates to the field of electronic components and, more specifically, resistors and the manufacture of resistors.

### BACKGROUND

Resistors are passive components used in circuits to provide electrical resistance by converting electrical energy into heat, which is dissipated. Resistors may be used in electrical circuits for many purposes, including limiting current, dividing voltage, sensing current levels, adjusting signal levels and biasing active elements. High power resistors may be required in applications such as motor vehicle controls, and such resistors may be required to dissipate many watts of electrical power. Where those resistors are also required to have relatively high resistance values, such resistors should be made to support resistive elements that are very thin and also able to maintain their resistance values under a full power load over a long period of time.

### SUMMARY

Resistors and methods of manufacturing resistors are described herein.

According to an embodiment, a resistor includes a resistive element and a plurality of separated conductive elements, forming heat dissipation elements. The plurality of conductive elements may be electrically insulated from one another via a dielectric material and thermally coupled to the resistive element via an adhesive material disposed between each of the plurality of conductive elements and a surface of the resistive element. The plurality of conductive elements may also be thermally coupled to the resistive element via solderable terminals.

According to another embodiment, a resistor is provided comprising a resistive element having an upper surface, a bottom surface, a first side surface, and an opposite second side surface. A first conductive element and a second conductive element are joined to the upper surface of the resistive element by an adhesive. The first and second conductive elements function as heat dissipation elements. A gap is provided between the first conductive element and the second conductive element. The positioning of the first conductive element and the second conductive element leave exposed portions of the adhesive on the upper surface of resistive element. A first conductive layer is positioned along a bottom portion of the resistive element. A second conductive layer is positioned along a bottom portion of the resistive element. A dielectric material covers upper surfaces of the first conductive element and the second conductive element and fills the gap between the first conductive element and the second conductive element. A dielectric material is deposited on an outer surface of the resistor, and may be deposited on both the top and bottom of the resistor.

A method of manufacturing a resistor is also provided. The method comprises the steps of: laminating a conductor to a resistive element using an adhesive; plating electrode layers to bottom portions of the resistive element; masking and patterning the conductor to divide the conductor into heat dissipation elements; depositing a dielectric material on a top surface and bottom surface of the resistor; and plating the sides of the resistor with solderable layers. In an embodiment, the resistive element may be patterned, for example using chemical etching, and thinned, for example using a laser, to achieve a target resistance value.

According to another embodiment, a resistor is provided comprising a resistive element coupled to first and second heat dissipation elements via an adhesive, wherein the first and second heat dissipation elements are electrically insulated from one another by a dielectric material. Electrodes are provided on a bottom surface of the resistive element. First and second solderable components of the resistor may be formed on at least the first and second heat dissipation elements and the resistive element. The first and second heat dissipation elements receive the majority of heat generated by the resistor, while receiving and conducting very little current. The electrodes may conduct the vast majority of the current of the device.

### BRIEF DESCRIPTION OF THE DRAWINGS

A more detailed understanding may be had from the following description, given by way of example in conjunction with the accompanying drawings wherein:

FIG. 1A shows a cross-sectional view of an example resistor;

FIG. 1B shows a cross-sectional view of an example resistor on a circuit board;

FIG. 1C shows a cross-sectional view of an example resistor attached to a circuit board;

FIG. 2A shows a cross-sectional view of an example resistor with a swage or stepped surface at an upper corner of each heat dissipation element;

FIG. 2B shows a cross-sectional view of an example resistor with a swage or stepped surface at an upper corner of each heat dissipation element;

FIG. 2C shows a cross-sectional view of a resistor with a swage or stepped surface at an upper corner of each heat dissipation element, attached to a circuit board;

FIG. 2D shows a cross-sectional view of a resistor with a swage or stepped surface at an upper corner of each heat dissipation element, with a portion of each heat dissipation element in closer proximity to the resistive element;

FIG. 2E shows a cross-sectional view of a resistor with a swage or stepped surface at an upper corner of each heat dissipation element with a portion of each heat dissipation element in closer proximity to the resistive element, attached to a circuit board;

FIG. 2F shows a top view of the example resistor shown in FIGS. 2A and 2D;

FIG. 2G shows a side view of the example resistor shown in FIGS. 2A and 2D;

FIG. 211 shows a bottom view of the example resistor shown in FIGS. 2A and 2D;

FIG. 3A shows a cross-section of an example resistor showing outer portions of the heat dissipation elements bent toward the resistive element;

FIG. 3B shows a cross-sectional view of an example resistor showing outer portions of the heat dissipation elements bent toward the resistive element attached to a circuit board;

FIG. 4A shows a top view of an example resistor;

FIG. 4B shows a side view of the resistor of FIG. 4A along with a magnified view of a portion of the resistor;

FIG. 4C shows a bottom view of the resistor of the resistor of FIG. 4A along with a magnified view of a portion of the resistor;

FIG. 4D shows an isometric view of the resistor of FIG. 4A with partial cutaway views for illustration purposes to show inner components or layers;

FIG. 5A shows a top view of a resistor;

FIG. 5B shows a side view of the resistor of FIG. 5A along with a magnified view of a portion of the resistor;

FIG. 5C shows a bottom view of the resistor of FIG. 5A along with a magnified view of a portion of the resistor;

FIG. 5D shows an isometric view of the resistor of FIG. 5A with cutaway views for illustration purposes to show inner components or layers;

FIG. 6A shows a top view of a resistor;

FIG. 6B shows a side view of the resistor of FIG. 6A along with a magnified view of a portion of the resistor;

FIG. 6C shows a bottom view of the resistor of FIG. 6A along with a magnified view of a portion of the resistor;

FIG. 6D shows an isometric view of the resistor of FIG. 6A with cutaway views for illustration purposes to show inner components or layers; and

FIG. 7 shows a flow chart of an example process of manufacture.

### DETAILED DESCRIPTION

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

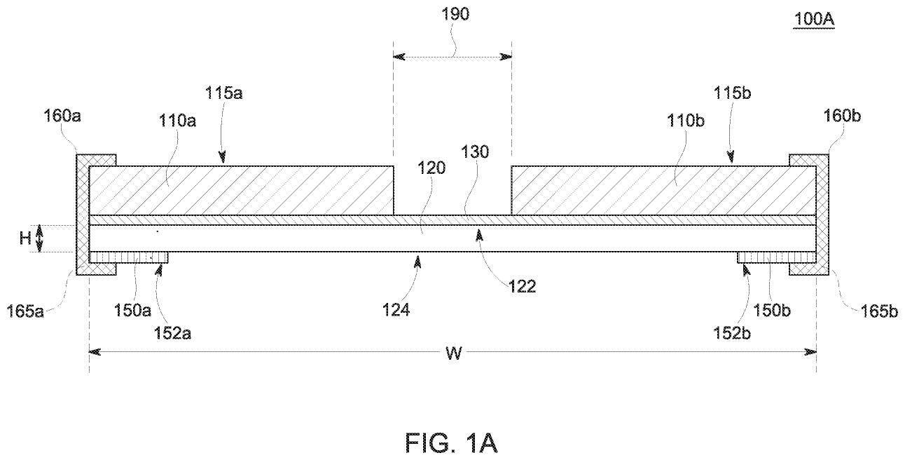

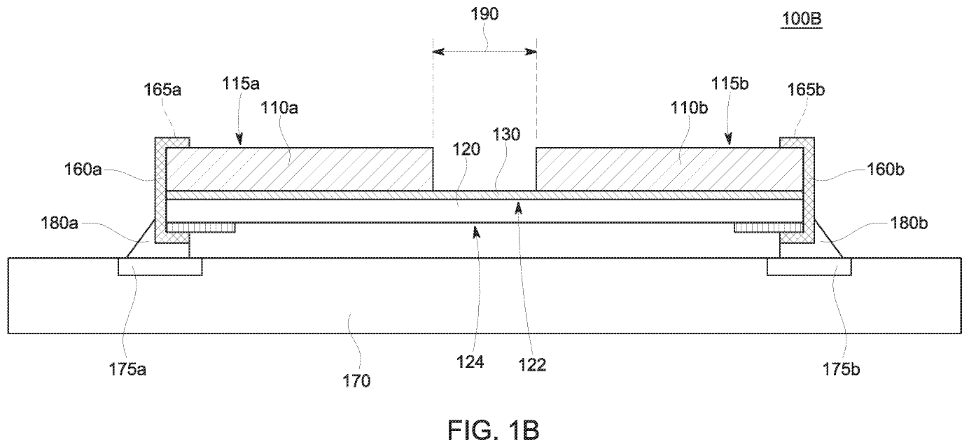

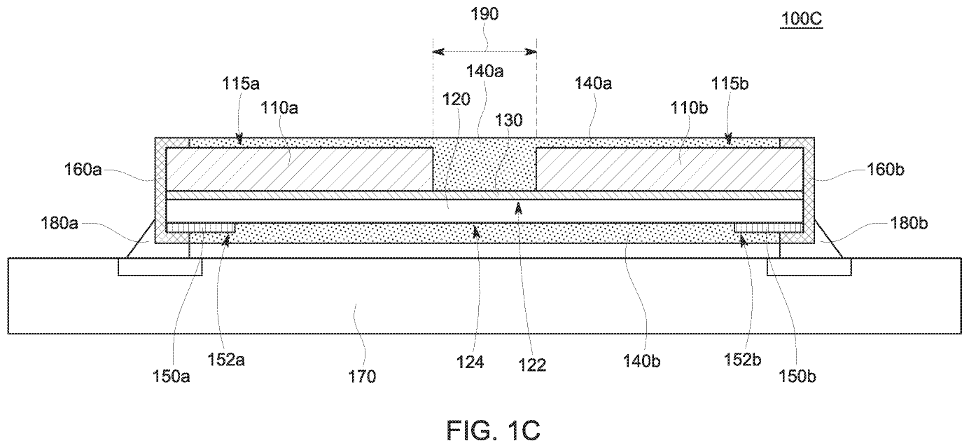

FIG. 1A is a diagram of a cross-section of an illustrative resistor 100. The resistor 100 illustrated in FIG. 1 includes a resistive element 120 positioned across the width of the resistor 100, and located between a first solderable terminals 160a and a second solderable terminals 160b, described in greater detail below. In the orientation shown in FIG. 1A for illustrative purposes, the resistive element has a top surface 122 and a bottom surface 124. The resistive element 120 is preferably a foil resistor. The resistive element may be formed from, by way of non-limiting example, copper, alloys of copper, nickel, aluminum, or manganese, or combinations thereof. Additionally, the resistive element may be formed from alloys of copper-nickel-manganese (CuNiMn), copper manganese tin (CuMnSn), copper nickel (CuNi), nickel-chromium-aluminum (NiCrAl), or nickel-chromium (NiCr), or other alloys known to those of skill in the art acceptable for use as a foil resistor. The resistive element 120 has a width “W” as designated in FIG. 1A. In addition, the resistive element 120 has a height or thickness of “H” as designated in FIG. 1A. The resistive element 120 has outer side surfaces or faces, facing in opposite directions, that may be generally planar or essentially flat.

As shown in FIG. 1A, a first heat dissipation element 110a and a second heat dissipation element 110b are positioned adjacent opposite side ends of the resistive element 120, with a gap 190 preferably provided between the first heat dissipation element 110a and a second heat dissipation element 110b. The heat dissipation elements 110a and 110b are formed from a thermally conductive material, and may preferably comprise copper, such as, for example, C110 or C102 copper. However, other metals with heat transfer properties, such as, for example, aluminum, may be used for the heat dissipation elements, and those of skill in the art will appreciate other acceptable metals for use as the heat dissipation elements 110a and 110b. The first heat dissipation element 110a and a second heat dissipation element 110b may have at least a portion that extends all the way to the outer side edges (or outer side surfaces) of the resistive element 120.

The heat dissipation elements 110a and 110b may be laminated, bonded, joined, or attached to the resistive element 120 via an adhesive material 130, which may comprise, by way of non-limiting example, materials such as DUPONT™, PYRALUX™, BOND PLY™, or other acrylic, epoxy, polyimide, or alumina filled resin adhesives in sheet or liquid form. Additionally, the adhesive material 130 may be composed of a material with electrically insulating and thermally conductive qualities. The adhesive material 130 may extend along the width “W” of the top surface 122 of the resistive element 120.

The heat dissipation elements 110a and 110b are positioned so that, when the resistor is attached to a circuit board, such as a printed circuit board (PCB), the heat dissipation elements 110a and 110b are positioned at the top of the resistor and distanced from the board. This can be seen in FIG. 1C.

As shown in FIG. 1A, a first 150a and second 150b electrode layers, which may also be referred to as conductive layers, are disposed along at least portions of the bottom surface 124 of the resistive element 120 at opposite side ends. The electrode layers 150a and 150b have opposite outer edges that preferably align with the opposite outer side edges (or outer side surfaces) of resistive element 120. Preferably, the first 150a and second 150b electrode layers are plated to the bottom surface 124 of the resistive element 120. In a preferred embodiment, copper may be used for the electrode layers. However, any platable and highly conductive metals may be used, as will be appreciated by those of skill in the art.

The outer side edges (or outer side surfaces) of the resistive element 120 and heat dissipation elements 110a and 110b, form solderable surfaces configured to receive solderable terminal 160a and 160b that may also be known as terminal platings. The outer side edges (or outer side surfaces) of the resistive element 120 and heat dissipation elements 110a and 110b also may preferably form planar, flat or smooth outer side surfaces, whereby the outer side edges of the resistive element 120 and heat dissipation elements 110a and 110b respectively align. As used herein, “flat” means “generally flat” and “smooth” means, i.e., within normal manufacturing tolerances. It is appreciated that the outer side surfaces may be somewhat or slightly rounded, bowed, curved or wavy based on the process used to form the resistor, while still being considered to be “flat.”

The solderable terminals 160a and 160b may be separately attached at the lateral ends 165a and 165b of the resistor 100 to allow the resistor 100 to be soldered to a circuit board, which is described in more detail below with respect to FIG. 1B. As shown in FIG. 1A, the solderable terminals 160a and 160b preferably include portions that extend at least partially along bottom surfaces 152a and 152b of the electrode layers 150a and 150b. As shown in FIG. 1A, the solderable terminals 160a and 160b preferably include portions that extend partially along upper surfaces 115a and 115b of the heat dissipation elements 110a and 110b. Further, the use of a conductive layer, such as 150a and 150b, on the side of the resistive element that will be closest to a printed circuit board (PCB) may aid in creating a strong solder joint and centering the resistor on the PCB pads during solder reflow, as shown in FIG. 1B and described herein.

FIG. 1B is a diagram of an illustrative resistor 100 mounted on a circuit board 170. In the example illustrated in FIG. 1B, the resistor 100 is mounted to the printed circuit board 170, also known as a PCB, using solder connections 180a and 180b between the solderable terminals 160a and 160b and corresponding solder pads 175a and 175b on the circuit board 170.

The heat dissipation elements 110a and 110b are coupled to the resistive element 120 via the adhesive 130. It is appreciated that the heat dissipation elements 110a and 110b may be thermally and/or mechanically and/or electrically coupled/connected or otherwise bonded, joined or attached to the resistive element 120. Of particular note, the solderable terminals 160a and 160b make the thermal and electrical connection between the resistive element 120 and the heat dissipation elements 110a and 110b. The thermal, electrical, and/or mechanical coupling/connection between the resistive element 120 and the lateral end of each of the heat dissipation elements 110a and 110b may enable the heat dissipation elements 110a and 110b to be used both as structural aspects for the resistor 100 and also as heat spreaders. Use of the heat dissipation elements 110a and 110b as a structural aspect for the resistor 100, may enable the resistive element 120 to be made thinner as compared to a self-supporting resistive elements, enabling the resistor 100 to be made to have a resistance of about 1 mΩ to 20Ω using foil thicknesses between about 0.015 inches and about 0.001 inches. In addition to providing support for the resistive element 120, efficient use of the heat dissipation elements 110a and 110b as heat spreaders may enable the resistor 100 to dissipate heat more effectively resulting in a higher power rating as compared to resistors that do not use heat spreaders. For example, a typical power rating for a 2512 size metal strip resistor is 1 W. Using the embodiments described herein, the power rating for a 2512 size metal strip resistor may be 3 W.

Further, the resistor 100 shown in FIGS. 1A-1C may reduce or eliminate risk of failure of the resistor due to the thermal coefficient of expansion (TCE).

In FIG. 1C, a dielectric material coating 140 is shown as dotted shading and it may be understood that the dielectric coating 140 may be applied to selected portions or all of the external surfaces of the resistor 100. A dielectric material 140 may be deposited on a surface or surfaces of the resistor 100, for example, by coating. The dielectric material 140 may fill spaces or gaps to electrically isolate components from each other. As shown in FIG. 1C, a first dielectric material 140a is deposited on an upper portion of the resistor. The first dielectric material 140a preferably extends between portions of the solderable terminals 160a and 160b, and covers the exposed upper surfaces 115a and 115b of the heat dissipation elements 110a and 110b. The first dielectric material 140a also fills in the gap 190 between, and keeps separate, the heat dissipation elements 110a and 110b, as well as covering the exposed portion of the adhesive 130 facing the gap 190. A second dielectric material 140b is deposited along the bottom surface of the resistive element 120, between portions of the solderable terminals 160a and 160b, and covering exposed portions of the electrode layers 150a and 150b, and the bottom surface 124 of the resistive element 120.

Based on modeling, it is predicted that approximately about 20% to about 50% of the heat generated during use of the resistor 100 may flow through and be dissipated via the heat dissipation elements 110a and 110b. Based on modeling, it is predicted that the heat dissipation elements 110a and 110b will carry none or virtually none of the current flowing through the resistor 100, and that the current flow through the heat dissipation elements 110a and 110b will be at or approach zero when in use. It is expected that all or virtually all of the current flow will be through the electrode layers 150a and 150b and the resistive element 120.

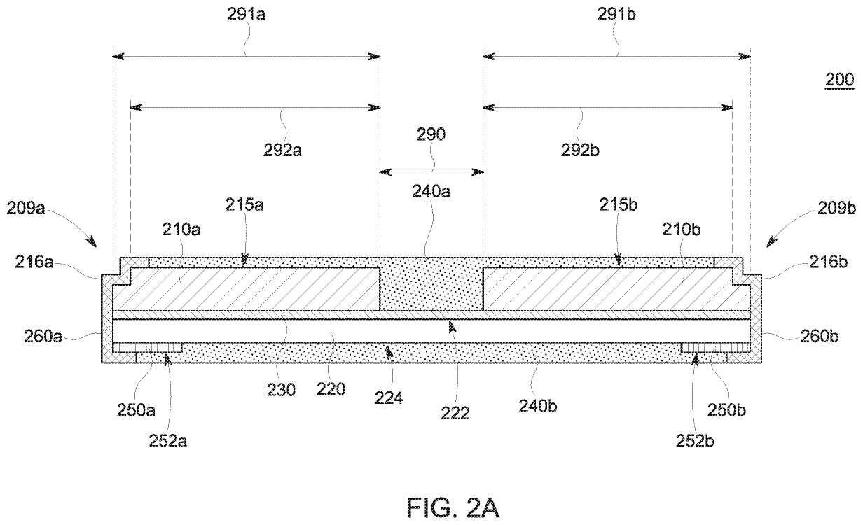

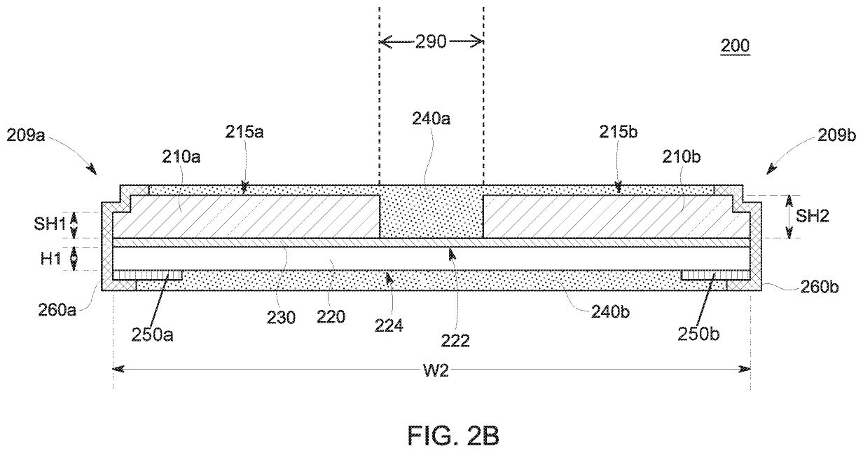

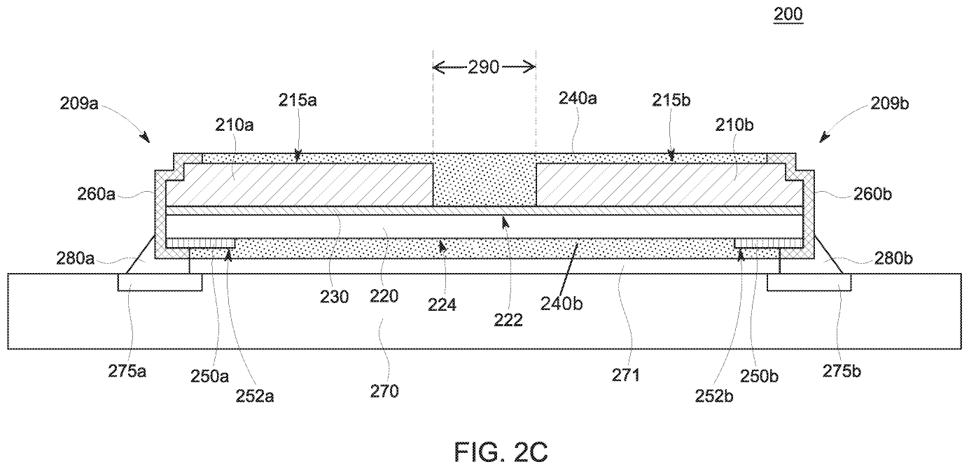

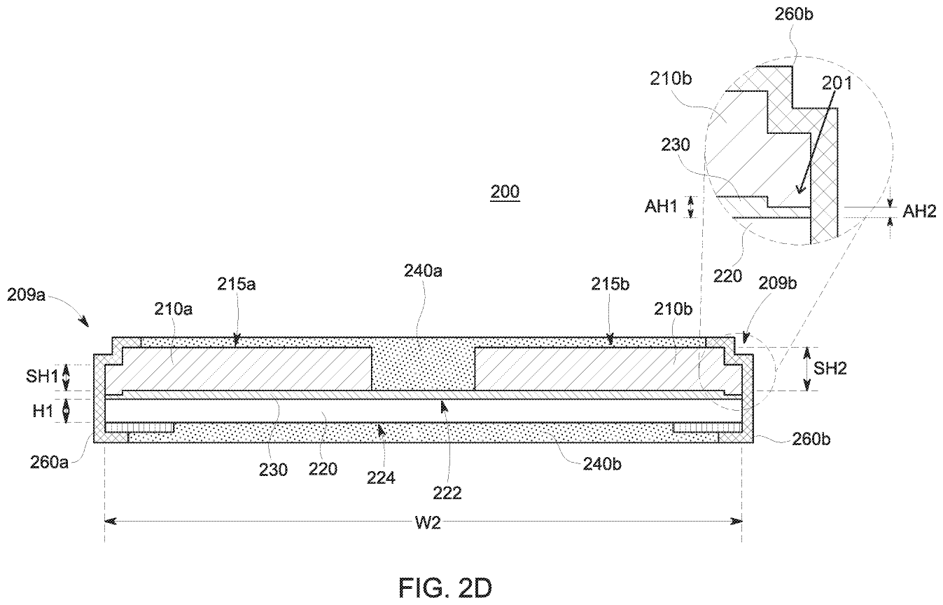

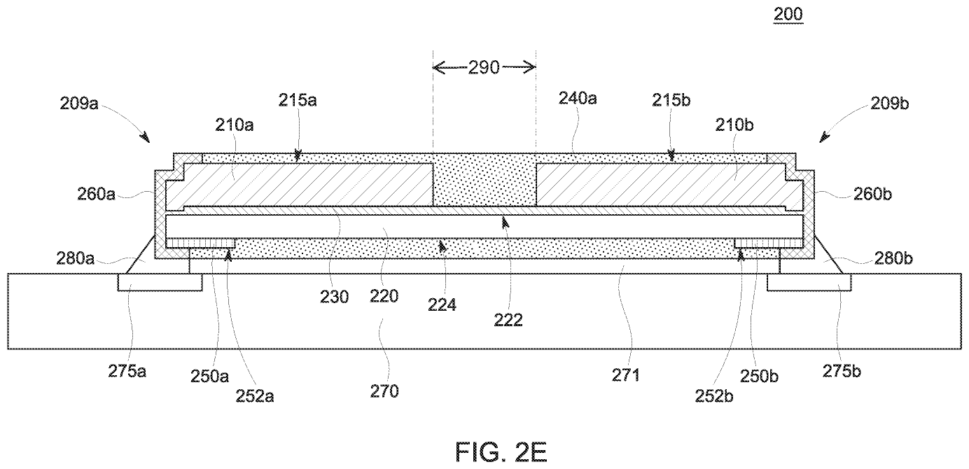

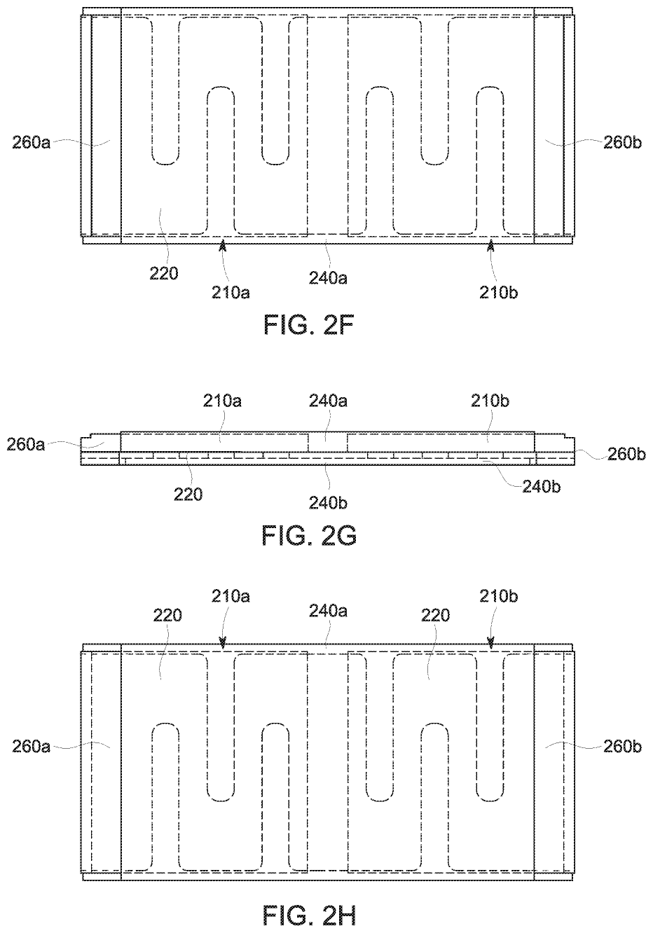

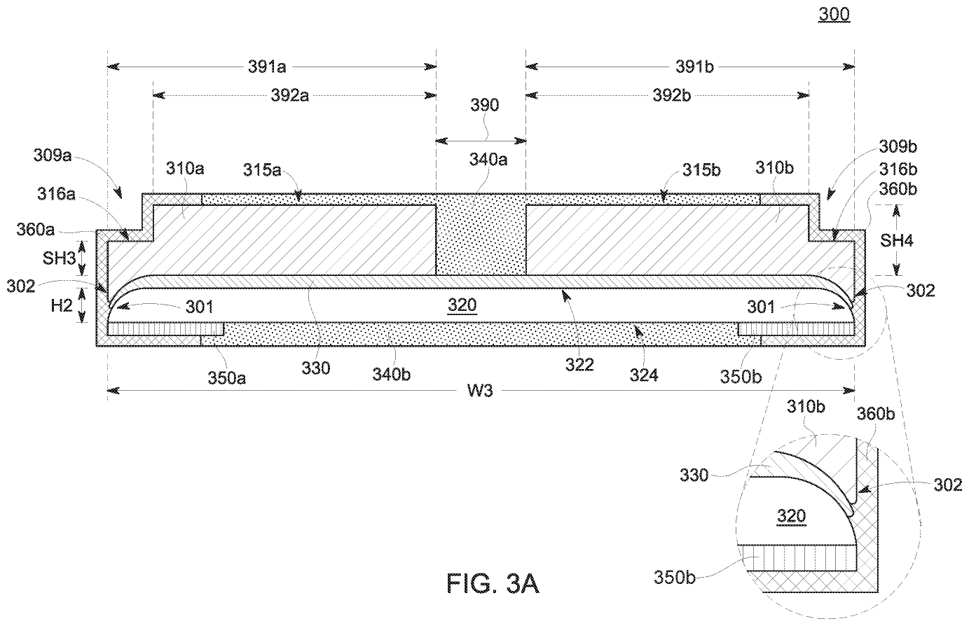

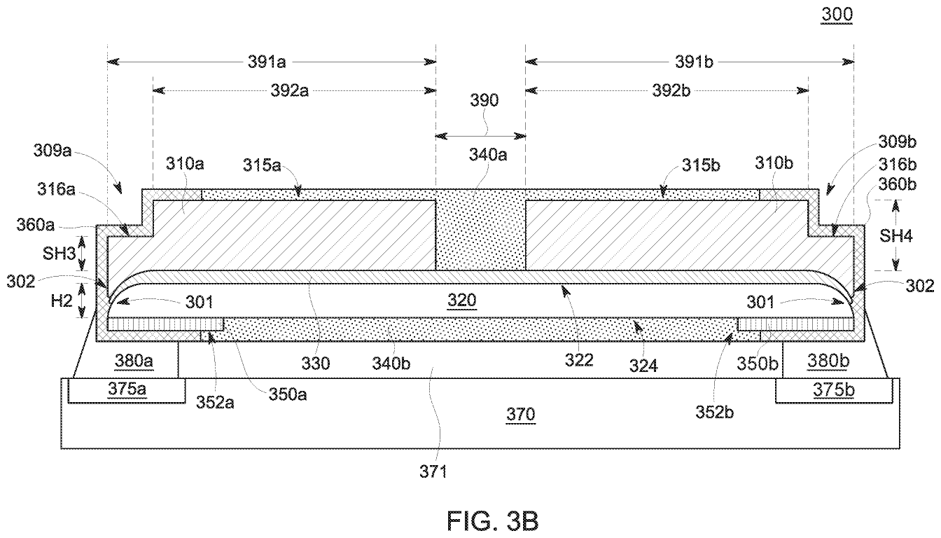

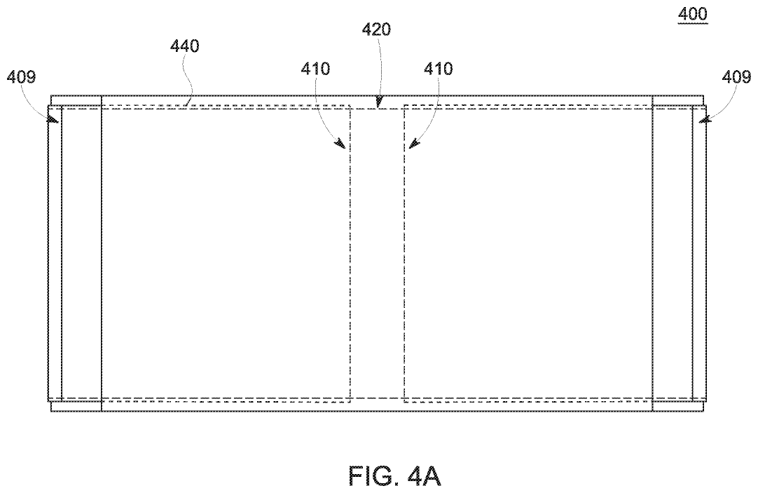

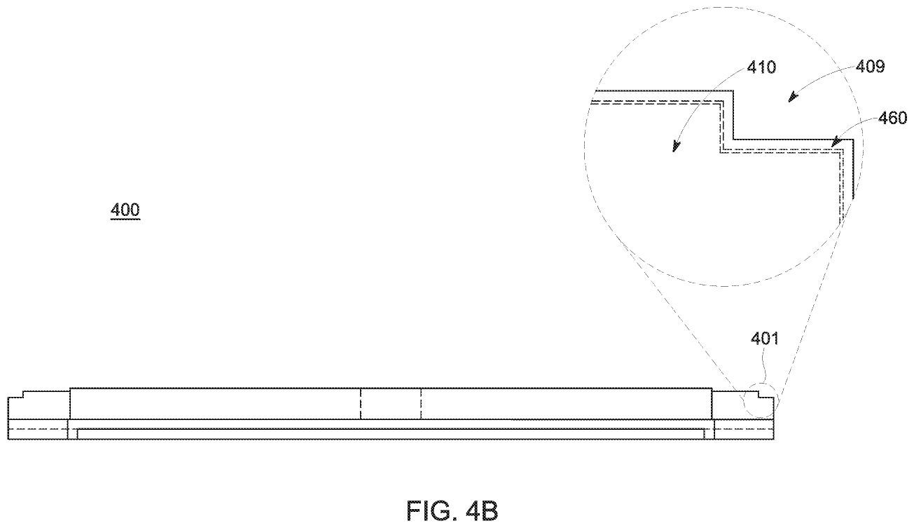

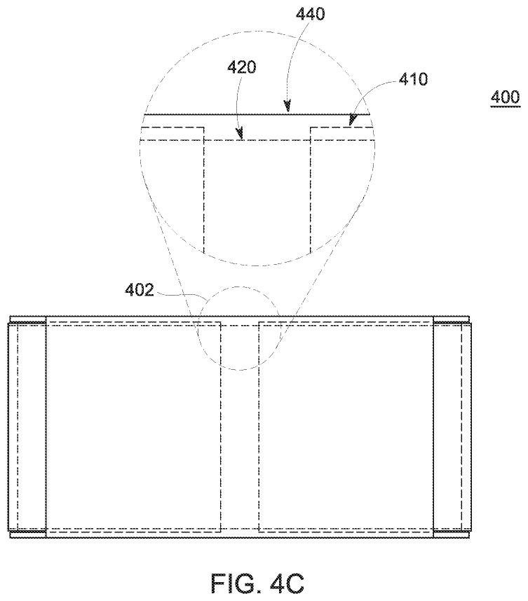

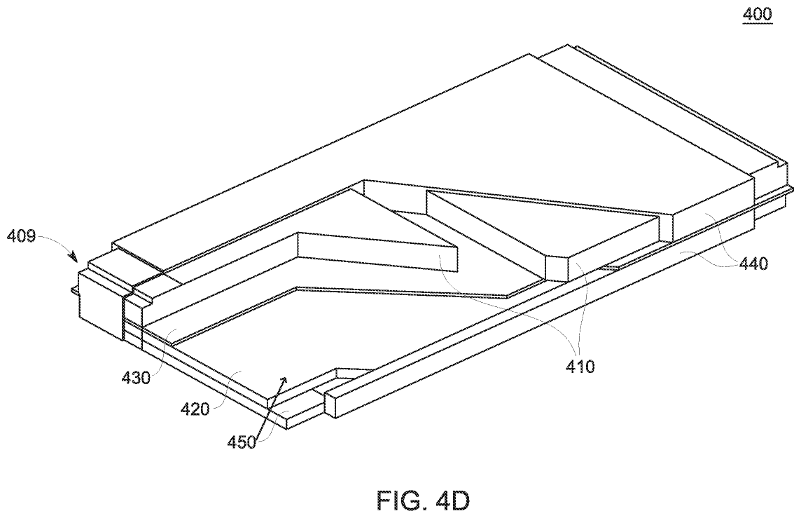

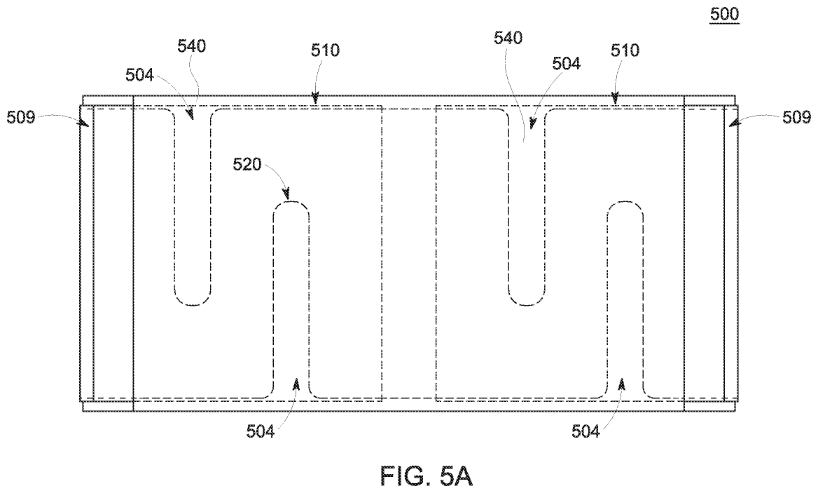

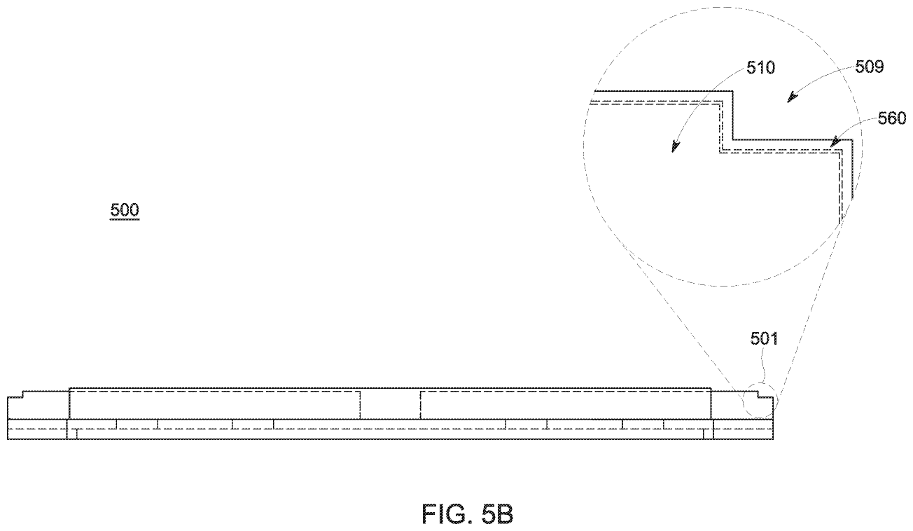

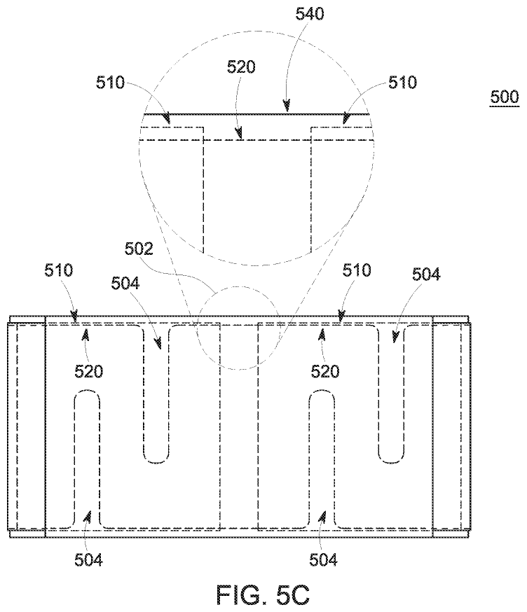

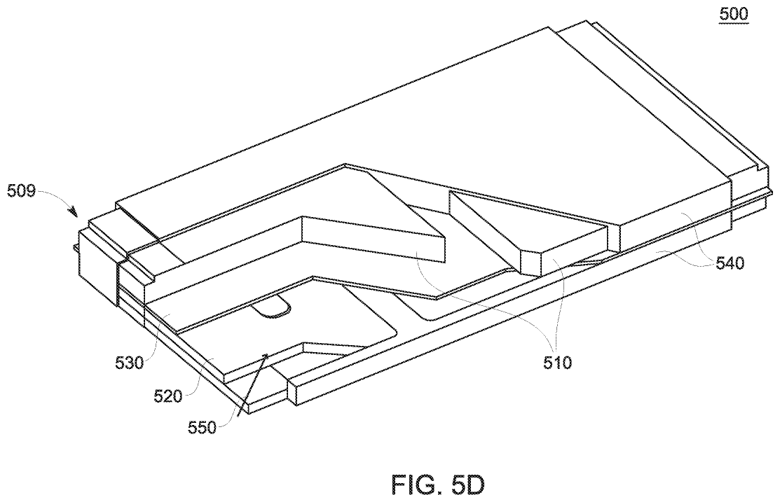

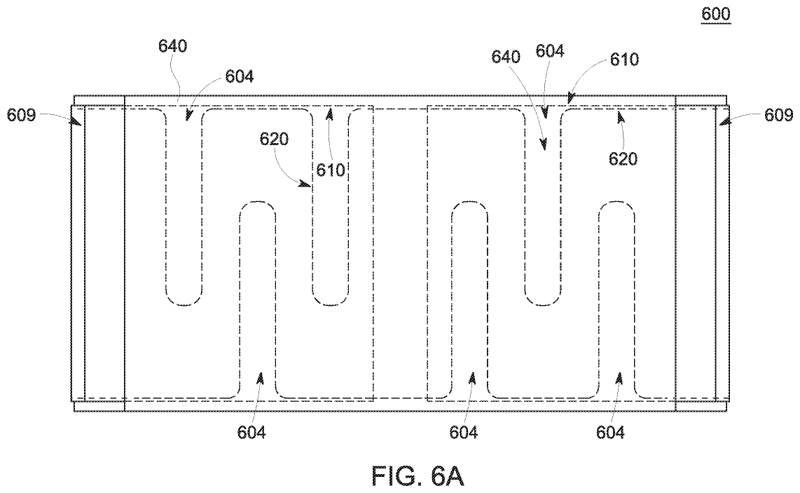

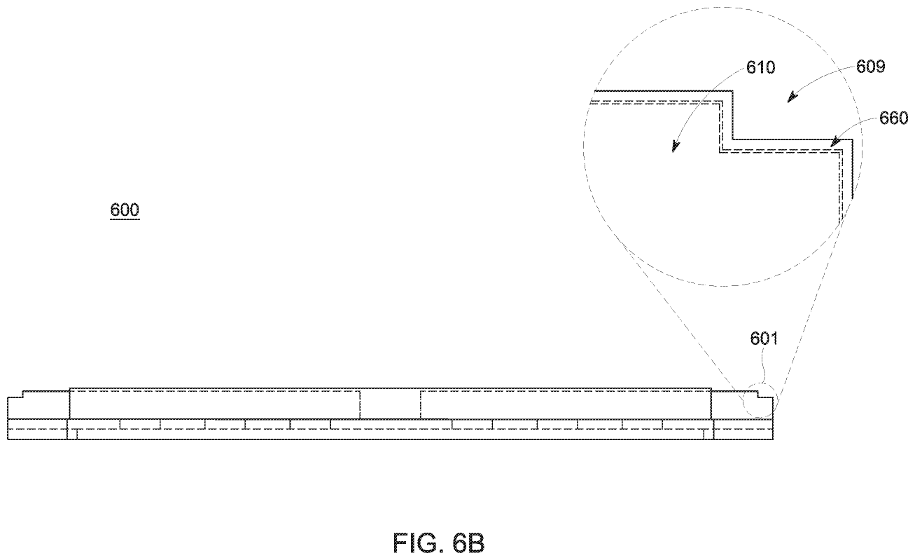

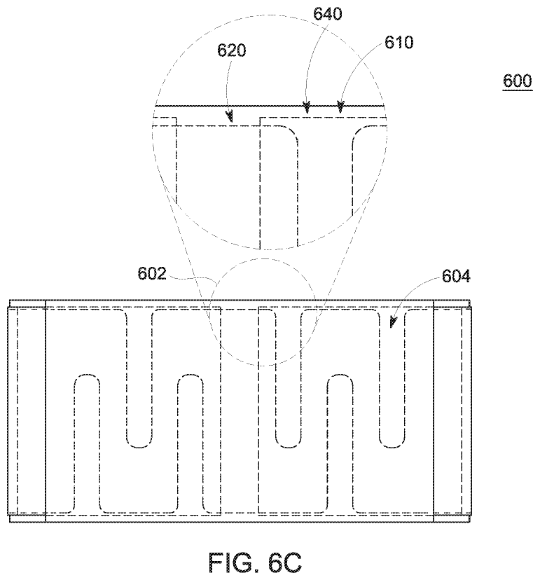

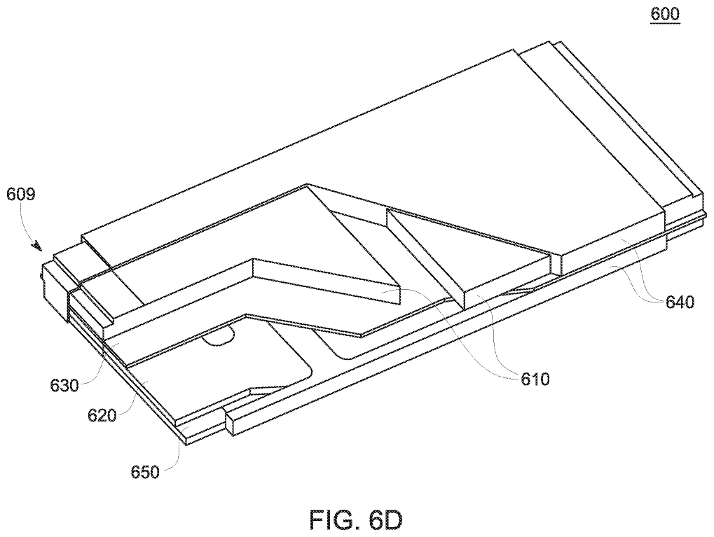

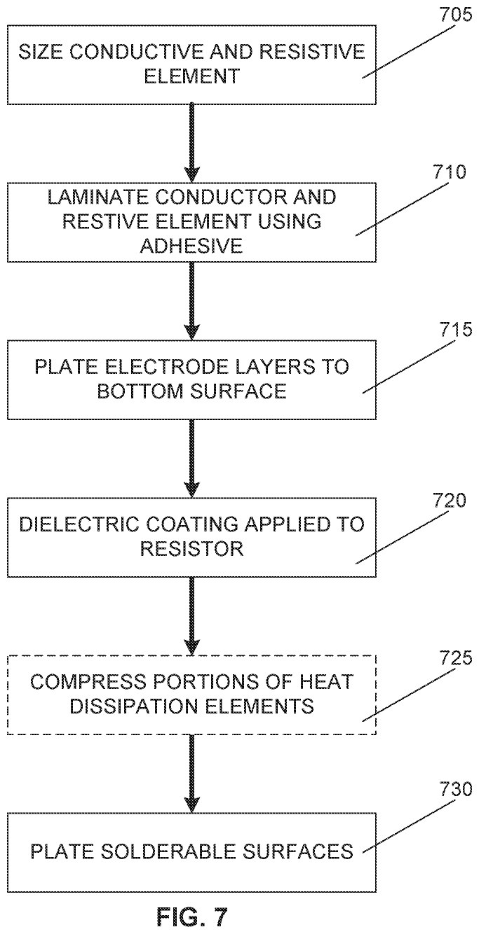

FIG. 2A is a diagram of a cross-section of an illustrative resistor 200 according to an alternative embodiment. In this embodiment, the resistor 200 may have swages, shown as 209a and 209b, at upper corners of the resistor 200. As used herein a swage is considered to include a step, portions of two different heights, an indentation, a groove, a ridge, or other shaped portion or molding. In one example, the swages 209a and 209b may be considered to be steps in the upper and outer corners of the heat dissipation elements 210a and 210b. The solderable elements 260a and 260b covering the heat dissipation elements 210a and 210b will also have corresponding swages in the upper and outer corners. The portions of the solderable elements 260a and 260b having the swages may be brought closer in proximity to the resistive element 220, as will be described in greater detail herein.

The swages 209a and 209b provide the heat dissipation elements 210a and 210b with upper inner top surfaces 215a and 215b lying or aligned along the same level or plane which preferably is positioned lower than the top of a dielectric material 240a, and lower outer top surfaces 216a and 216b lying or aligned along the same level or plane positioned lower than the uppermost inner top surface. As shown, the heat dissipation elements 210a and 210b including the swages 209a and 209b provide that the upper inner top surfaces 215a and 215b have a height greater than the height of the lower outer top surfaces 216a and 216b. The swages 209a and 209b further provide the heat dissipation elements 210a and 210b with a complete length shown as 291a and 291b, and a length to the beginning of the swages 209a, 209b portion shown as 292a and 292b.

The swages 209a and 209b provide the heat dissipation elements 210a and 210b with an outer portion having a height shown as SH1 in FIG. 2B, and an inner portion having a height shown as SH2. In the preferred embodiment, SH2 is greater than SH1. The overall height SH2 of the heat dissipation elements 210a and 210b may be, for example, an average of two times greater than the height H1 of the resistive element 220.

It is appreciated that the swages 209a and 209b may have one or more variations in shape, providing the heat dissipation elements 210a and 210b with an upper portion that is stepped, angled or rounded. The solderable elements 260a and 260b covering the heat dissipation elements 210a and 210b in those instances may have corresponding shapes.

The resistor 200 illustrated in FIG. 2B includes a resistive element 220 preferably positioned across an area of the resistor 200, such as along at least portions of the length and width of the resistor 200. The resistive element has a top surface 222 and a bottom surface 224. The resistive element 220 is preferably a foil resistor. The resistive element may be formed from, by way of non-limiting example, copper, alloys of copper, nickel, aluminum, or manganese, or combinations thereof. Additionally, the resistive element may be formed from alloys of copper-nickel-manganese (CuNiMn), copper manganese tin (CuMnSn), copper nickel (CuNi), nickel-chromium-aluminum (NiCrAl), or nickel-chromium (NiCr), or other alloys known to those of skill in the art acceptable for use as a foil resistor. The resistive element 220 has a width “W2” as designated in FIG. 2B. In addition, the resistive element 220 has a height or thickness of “H1” as designated in FIG. 2B. The resistive element 220 has outer side surfaces or faces, facing in opposite directions, that are generally planar or essentially flat.

A first solderable terminal 260a and the second solderable terminal 260b cover opposite side ends of the resistor. These may be formed in the same manner as described with respect to solderable terminals 160a and 160b. The solderable terminals 260a, 260b extend from the electrodes 250a, 250b, along the sides of the resistor, and along at least part of the upper inner top surfaces 215a and 215b of the heat dissipation elements 210a, 210b.

The first heat dissipation element 210a and the second heat dissipation element 210b are positioned adjacent opposite side ends of the resistive element 220, with a gap 290 preferably provided between the first heat dissipation element 210a and a second heat dissipation element 210b. The heat dissipation elements 210a and 210b are formed from a thermally conductive material, and may preferably comprise copper, such as, for example, C110 or C102 copper. However, other metals with heat transfer properties, such as, for example, aluminum, may be used for the conductive elements, and those of skill in the art will appreciate other acceptable metals for use as the conductive elements. The first heat dissipation element 210a and a second heat dissipation element 210b may extend all the way to the outer side edges (or outer side surfaces) of the resistive element 220. The outermost side edges (side surfaces) of the heat dissipation elements 210a, 210b and the outer side edges (or outer side surfaces) of the resistive element 220 may be aligned and form flat outer side surfaces of the resistor.

The heat dissipation elements 210a and 210b may be laminated, bonded, joined, or attached to the resistive element 220 via an adhesive material 230, which may comprise, by way of non-limiting example, materials such as DUPONT™, PYRALUX™, BOND PLY™, or other acrylic, epoxy, polyimide, or alumina filled resin adhesives in sheet or liquid form. Additionally, the adhesive material 230 may be composed of a material with electrically insulating and thermally conductive properties. The adhesive material 230 preferably extends along the entire width “W2” of the top surface 222 of the resistive element 220.

FIG. 2C shows that the heat dissipation elements 210a and 210b may be positioned so that, when the resistor is attached to a circuit board 270, the heat dissipation elements 210a and 210b are at the top of the resistor and distanced from a board 270.

A first 250a and a second 250b electrode layer, which may also be referred to as conductive layers, are disposed along at least portions of the bottom surface 224 of the resistive element 220 at opposite side ends. The electrode layers 250a and 250b have opposite outer edges that preferably align with the opposite outer side edges (or outer side surfaces) of resistive element 220. Preferably, the first 250a and second 250b electrode layers are plated to the bottom surface 224 of the resistive element 220. In a preferred embodiment, copper may be used for the electrode layers. However, any platable and highly conductive metals may be used, as will be appreciated by those of skill in the art.

The outer side edges (or outer side surfaces) of the resistive element 220 and heat dissipation elements 210a and 210b, form solderable surfaces configured to receive solderable terminal 260a and 260b that may also be known as terminal platings. Portions of the outer side edges (or outer side surfaces) beneath the swage 209a and 209b of solderable terminals 260a and 260b may preferably form planar, flat, or smooth outer side surfaces. As used herein, “flat” means “generally flat” and “smooth” means “generally smooth,” i.e., within normal manufacturing tolerances. It is appreciated that the outer side surfaces of the solderable terminals 260a and 260b may be somewhat or slightly rounded, bowed, curved, or wavy beneath the swage 209a and 209b based on the process used to form the resistor, while still being considered to be “flat.”

As shown in FIG. 2C the solderable terminals 260a and 260b may be separately attached at the lateral ends of the resistor 200 to allow the resistor 200 to be soldered to a circuit board 270. The solderable terminals 260a and 260b preferably include portions that extend at least partially along bottom surfaces 252a and 252b of the electrode layers 250a and 250b. The solderable terminals 260a and 260b preferably include portions that extend partially along upper surfaces 215a and 215b of the heat dissipation elements 210a and 210b.

As shown in FIG. 2C, the use of electrode layers, such as 250a and 250b, on the side of the resistive element may be closest to the circuit board 270, also referred to as PCB 270, and aid in creating a strong solder joint and centering the resistor 200 on the PCB pads 275a and 275b during solder reflow. The resistor 200 is mounted to the circuit board 270 using solder connections 280a and 280b between the solderable terminals 260a and 260b and corresponding solder pads 275a and 275b on the circuit board 270.

The heat dissipation elements 210a and 210b are coupled to the resistive element 220 via the adhesive 230. It is appreciated that the heat dissipation elements 210a and 210b may be thermally and/or mechanically and/or electrically coupled/connected or otherwise bonded, joined or attached to the resistive element 220. The solderable terminals 260a and 260b provide further thermal connection between the resistive element 220 and the heat dissipation elements 210a and 210b.

The resistor 200 preferably has dielectric material coatings 240a and 240b applied (e.g., by coating) to certain external or exposed surfaces of the resistor 200 as shown. The dielectric material 240a and 240b may fill spaces or gaps to electrically isolate components from each other. The first dielectric material 240a is deposited on an upper portion of the resistor. The first dielectric material 240a preferably extends between portions of the solderable terminals 260a and 260b, and covers the exposed upper surfaces 215a and 215b of the heat dissipation elements 210a and 210b. The first dielectric material 240a also fills in the gap 290 between, and separates, the heat dissipation elements 210a and 210b, as well as covering the exposed portion of the adhesive 230 facing the gap 290. The second dielectric material 240b is deposited along the bottom surface 224 of the resistive element 220, between portions of the solderable terminals 260a and 260b, and covering exposed portions of the electrode layers 250a and 250b. There may be a gap 271 between the second dielectric material 240b and the circuit board 270 when the resistor is mounted.

FIG. 2D is a diagram of a cross-section of the illustrative resistor 200 in an embodiment wherein a portion of each of the heat dissipation elements 210a and 210b is brought into closer proximity to the resistive element 220. The swages 209a and 209b may be formed by compressing a portion of the heat dissipation elements 210a and 210b or otherwise pressing those portions toward the resistive element 220, so that each heat dissipation element has at least a portion, such as an extension portion, that extends toward the resistive element 220. The adhesive layer 230 may also be compressed in certain areas 201. The compression force may be the result of a die and a punch, which may press the heat dissipation elements 210a and 210b down from the upper surfaces 215a and 215b to form the swages 209a and 209b. In this example, the adhesive layer 230 may be compressed or thinner in the areas 201 below the swages 209a and 209b such that a height AH2 of the adhesive layer 230 below the swages 209a and 209b is less than a height AH1 of the remaining portion of the adhesive layer. The extension of portions of the heat dissipation elements 210a and 210b toward the resistive element 220 brings the heat dissipation elements 210a and 210b and the resistive element 220 into a closer proximity (i.e., AH2), which promotes better heat transfer from the resistive element to the heat dissipation elements 210a and 210b.

FIG. 2E shows the resistor having the portion of each of the heat dissipation elements 210a and 210b brought into closer proximity to the resistive element 220 attached to a circuit board 270. The structure shown in FIG. 2E may have components similar to those described above with reference to FIG. 2C and therefore may also utilize the descriptions above.

FIG. 2F shows a top view of the example resistor shown in FIGS. 2A and 2D with portions shown in phantom to view the interior of the resistor.

FIG. 2G shows a side view of the example resistor shown in FIGS. 2A and 2D with portions shown in phantom to view the interior of the resistor,

FIG. 2H shows a bottom view of the example resistor shown in FIGS. 2A and 2D with portions shown in phantom to view the interior of the resistor.

The thermal, electrical, and/or mechanical coupling/connection between the resistive element 220 and the lateral end of each of the heat dissipation elements 210a and 210b may enable the heat dissipation elements 210a and 210b to be used both as structural aspects for the resistor 200 and also as heat spreaders.

FIG. 3A is a diagram of a cross-section of an illustrative resistor 300 according to another embodiment. The resistor 300 includes a resistive element 320 positioned across an area of the resistor 300, such as along at least portions of the length and width of the resistor 300. The resistive element 320 has a top surface 322 and a bottom surface 324. The resistive element 320 is preferably a foil resistor. The resistive element may be formed from, by way of non-limiting example, copper, alloys of copper, nickel, aluminum, or manganese, or combinations thereof. Additionally, the resistive element may be formed from alloys of copper-nickel-manganese (CuNiMn), copper manganese tin (CuMnSn), copper nickel (CuNi), nickel-chromium-aluminum (NiCrAl), or nickel-chromium (NiCr), or other alloys known to those of skill in the art acceptable for use as a foil resistor. The resistive element 320 has a width “W3.” In addition, the resistive element 320 has a height or thickness of “H2.” The resistive element 320 has outer side surfaces or faces, facing in opposite directions, that are generally planar or essentially flat.

The first heat dissipation element 310a and the second heat dissipation element 310b are positioned adjacent opposite side ends of the resistive element 320, with a gap 390 preferably provided between the first heat dissipation element 310a and a second heat dissipation element 310b. The heat dissipation elements 310a and 310b are formed from a thermally conductive material, and may preferably comprise copper, such as, for example, C110 or C102 copper. However, other metals with heat transfer properties, such as, for example, aluminum, may be used for the conductive elements, and those of skill in the art will appreciate other acceptable metals for use as the conductive elements.

The heat dissipation elements 310a and 310b may be laminated, bonded, joined, or attached to the resistive element 320 via an adhesive material 330, which may comprise, by way of non-limiting example, materials such as DUPONT™, PYRALUX™, BOND PLY™, or other acrylic, epoxy, polyimide, or alumina filled resin adhesives in sheet or liquid form. Additionally, the adhesive material 330 may be composed of a material with electrically insulating and thermally conductive properties. The adhesive material 330 preferably extends along the entire width W3 of the top surface 322 of the resistive element 320.

A first 350a and a second 350b electrode layer, which may also be referred to as conductive layers, are disposed along at least portions of the bottom surface 324 of the resistive element 320 at opposite side ends. The electrode layers 350a and 350b have opposite outer edges that preferably align with the opposite outer side edges (or outer side surfaces) of resistive element 320. Preferably, the first 350a and second 350b electrode layers are plated to a bottom surface 324 of the resistive element 320. In a preferred embodiment, copper may be used for the electrode layers. However, any platable and highly conductive metals may be used, as will be appreciated by those of skill in the art.

The resistor 300 preferably has dielectric material coatings 340a and 340b applied (e.g., by coating) to certain external or exposed surfaces of the resistor 300 as shown. The dielectric material 340a and 340b may fill spaces or gaps to electrically isolate components from each other. The first dielectric material 340a is deposited on an upper portion of the resistor 300. The first dielectric material 340a covers upper surfaces 315a and 315b of the heat dissipation elements 310a and 310b. The first dielectric material 340a also fills in the gap 390 between, and separates, the heat dissipation elements 310a and 310b, as well as covering the exposed portion of the adhesive layer 330 facing the gap 390. The second dielectric material 340b is deposited on the bottom surface 324 of the resistive element 320 and covers portions of the electrode layers 350a and 350b.

As shown in FIG. 3A, a portion of each of the heat dissipation elements 310a and 310b may be brought into closer proximity to the resistive element 320. Swages 309a and 309b may be formed by compressing a portion of the heat dissipation elements 310a and 310b or otherwise pressing those portions toward the resistive element 320. The adhesive layer 330 may also be compressed in certain areas 301. The compression force may be a result of a die and a punch, which may press the heat dissipation elements 310a and 310b down from the upper surfaces 315a and 315b to form the swages 309a and 309b. In this example, the adhesive layer 330 may be thinner in the areas 301 below the swages 309a and 309b and may be bent down along with the heat dissipation elements 310a and 310b.

Each heat dissipation element may have at least a portion, such as an extension portion 302, that extends toward, adjacent to or around, as the case may be, the resistive element 320. The extended portion 302 of the first heat dissipation element 310a and the extended portion 302 of the second heat dissipation element 310b may be pressed or otherwise positioned to extend along the outer side edges (or outer side surfaces) of the adhesive layer 330. In an embodiment, extended portion 302 of the first heat dissipation element 310a and the extended portion 302 of the second heat dissipation element 310b may extend to the resistive element 320. The outer side edges (side surfaces) of the extended portion 302 of the heat dissipation elements 310a, 310b and the outer side edges (or outer side surfaces) of the resistive element 320 may be aligned and form outer side surfaces of the resistor 300.

The adhesive layer 330 and bottom portions of the heat dissipation elements 310a and 310b may curve down towards the resistive element 320 in the bent areas 301. As shown in the magnified view, the bottom edges of the heat dissipation elements 310a and 310b, the outer edges of the adhesive layer 330 may be rounded off.

As used herein a swage is considered to include a step, indentation, groove, ridge, or other shaped molding. In one example, the swages 309a and 309b may be considered to be steps in the upper and outer corners of the heat dissipation elements 310a and 310b.

The swages 309a and 309b provide the heat dissipation elements 310a and 310b with upper inner top surfaces 315a and 315b lying or aligned along the same level or plane which preferably is positioned lower than the top of a dielectric material 340a, and lower outer top surfaces 316a and 316b lying or aligned along the same level or plane positioned lower than the uppermost inner top surface. As shown, the heat dissipation elements 310a and 310b including the swages 309a and 309b provide that the upper inner top surfaces 315a and 315b have a height greater than the height of the lower outer top surfaces 316a and 316b. The swages 309a and 309b further provide the heat dissipation elements 310a and 310b with a complete length shown as 391a and 391b, and a length to the beginning of the swages 309a, 309b portion shown as 392a and 392b.

The swages 309a and 309b provide the heat dissipation elements 310a and 310b with an outer portion having a height SH3 and an inner portion having a height shown as SH4. In the preferred embodiment, SH4>SH3. The overall height SH4 of the heat dissipation elements 310a and 310b may be, for example, an average of two times greater than the height 112 of the resistive element 320.

It is appreciated that the swages 309a and 309b may have one or more variations in shape, providing the heat dissipation elements 310a and 310b with an upper portion that is stepped, angled or rounded.

A first solderable terminal 360a and a second solderable terminal 360b may be formed on opposite side ends of the resistor 300 in the same manner as described with respect to solderable terminals 160a, 160b and 260a, 260b. The solderable terminals 360a, 360b extend from the electrodes 350a, 350b, along the sides of the resistor, and along at least part of the upper inner top surfaces 315a and 315b of the heat dissipation elements 310a, 310b. The first dielectric material 340a preferably extends between the solderable terminals 360a and 360b on the upper surface of the resistor 300. The second dielectric material 340b extends along the bottom surface 324 of the resistive element 320 between portions of the solderable terminals 360a and 360b.

The outer side edges (or outer side surfaces) of the resistive element 320 and the heat dissipation elements 310a and 310b, form solderable surfaces configured to receive the solderable terminals 360a and 360b that may also be known as terminal platings. Portions of the outer side edges (or outer side surfaces) beneath the swage 309a and 309b of solderable terminals 360a and 360b may preferably form planar, flat, or smooth outer side surfaces. As used herein, “flat” means “generally flat” and “smooth” means “generally smooth,” i.e., within normal manufacturing tolerances. It is appreciated that the outer side surfaces of the solderable terminals 360a and 360b may be somewhat or slightly rounded, bowed, curved, or wavy beneath the swage 309a and 309b based on the process used to form the resistor, while still being considered to be “flat.” The compression of the adhesive layer 330 and the heat dissipation elements 310a and 310b may bring the heat dissipation elements 310a and 310b and the resistive element 320 into a closer proximity in bent areas 301. This may promote adhesion of the solderable terminals 360a, 360b to the heat dissipation elements 310a and 310b and the resistive element 320.

The solderable terminals 360a and 360b covering the heat dissipation elements 310a and 310b will have corresponding swages in the upper and outer corners. In this manner, the portions of the solderable elements 360a and 360b having the swages are brought closer in proximity to the resistive element 320.

The solderable terminals 360a and 360b preferably include portions that extend partially along upper surfaces 315a and 315b of the heat dissipation elements 310a and 310b.

As described above, the compression and bending of the adhesive layer 330 brings the heat dissipation elements 310a and 310b and the resistive element 320 in closer proximity to one another. The solderable terminals 360a and 360b are able to bridge the adhesive material 330.

FIG. 3B shows that the heat dissipation elements 310a and 310b may be positioned so that, when the resistor is attached to a circuit board 370, also referred to as a PCB 370, the heat dissipation elements 310a and 310b are at the top of the resistor and distanced from a board 370. There may be a gap 371 between the second dielectric material 340b and the circuit board 370 when the resistor is mounted.

The solderable terminals 360a and 360b may be separately attached at the lateral ends of the resistor 300 to allow the resistor 300 to be soldered to the circuit board 370. The solderable terminals 360a and 360b preferably include portions that extend at least partially along bottom surfaces 352a and 352b of the electrode layers 350a and 350b.

The electrode layers 350a and 350b may be closest to the circuit board 370, and aid in creating a strong solder joint and centering the resistor 300 on PCB pads 375a and 375b during solder reflow. The resistor 300 is mounted to the circuit board 370 using solder connections 380a and 380b between the solderable terminals 360a and 360b and corresponding solder pads 375a and 375b on the circuit board 370.

The heat dissipation elements 310a and 310b are coupled to the resistive element 320 via the adhesive 330. It is appreciated that the heat dissipation elements 310a and 310b may be thermally and/or mechanically and/or electrically coupled/connected or otherwise bonded, joined or attached to the resistive element 320. The solderable terminals 360a and 360b provide further thermal connection between the resistive element 320 and the heat dissipation elements 310a and 310b. The thermal, electrical, and/or mechanical coupling/connection between the resistive element 320 and the lateral end of each of the heat dissipation elements 310a and 310b may enable the heat dissipation elements 310a and 310b to be used both as structural aspects for the resistor 300 and also as heat spreaders.

The use of the heat dissipation elements 210a and 210b as a structural element for resistor 200 and the use of the heat dissipation elements 310a and 310b as a structural aspect for the resistor 300, may enable the resistive elements 220 and 320 to be made thinner as compared to a self-supporting resistive elements, enabling the resistors 200 and 300 to be made to have a resistance of about 1 mΩ to 30Ω using foil thicknesses between about 0.015 inches and about 0.001 inches. In addition to providing support for the resistive elements 220 and 320, efficient use of the heat dissipation elements 210a and 210b and the heat dissipation elements 310a and 310b as heat spreaders may enable the resistors 200 and 300 to dissipate heat more effectively resulting in a higher power rating as compared to resistors that do not use heat spreaders. For example, a typical power rating for a 2512 size metal strip resistor is 1 W. Using the embodiments described herein, the power rating for a 2512 size metal strip resistor may be 3 W.

Further, the resistors 200 and 300 may reduce or eliminate risk of failure of the resistor due to the thermal coefficient of expansion (TCE).

Based on modeling, it is predicted that approximately about 20% to about 50% of the heat generated during use of the resistors 200 and 300 may flow through and be dissipated via the heat dissipation elements 210a, 210b, 310a, and 310b. Based on modeling, it is predicted that the heat dissipation elements 210a, 210b, 310a, and 310b will carry none or virtually none of the current flowing through the resistors 200 and 300, and that the current flow through the heat dissipation elements 210a, 210b, 310a, and 310b will be at or approach zero when in use. It is expected that all or virtually all of the current flow will be through the electrode layers 250a, 250b, 350a, and 350b and the resistive elements 220 and 320.

FIG. 4A shows a top view of a resistor 400 with partially transparent layers for illustrative purposes. The resistor 400 may have swages 409 and may have a general arrangement as described above with respect to FIGS. 2A-2H or FIGS. 3A-3B. The resistor 400 may be similar to resistor 200 or resistor 300 and therefore may also utilize the descriptions of resistor 200 or resistor 300. FIG. 4A shows a transparent top view of the resistor 400, illustrating heat dissipation elements 410 (similar to the heat dissipation elements 210a, 210b or 310a, 310b above), a resistive element 420 (similar to the resistive element 220 or 320 above) and a dielectric material 440 (similar to the dielectric material 240a, 240b or 340a, 340b above). The resistive element 420 may have a substantially uniform surface area. As can be seen in FIG. 4A, the heat dissipation elements 410 may have a width that is greater than the width of the resistive element 420 by approximately 2-4%.

FIG. 4B shows a side view of the resistor 400 with partially transparent layers for illustrative purposes. A close up view 401 of an upper corner of the resistor 400 is shown where heat dissipation elements 410 may be seen covered by a solderable element 460. A swage 409 may located be at the upper and outer corner of the heat dissipation elements 410 and corresponding solderable element 460.

FIG. 4C shows a bottom view of the resistor 400 with partially transparent layers for illustrative purposes. A close up view 402 of the resistor 400 shows a detailed view of the middle portion of the resistor 400 showing the resistive element 420, the heat dissipation elements 410, and the dielectric material 440 covering external portions of the conductive elements 410 and the resistive element 420.

FIG. 4D shows an isometric view of the resistor 400 with cut away views for illustrative purposes. An adhesive material 430 (similar to adhesive material 230 or 330) formed on an upper surface of the resistive element 420 may thermally bond the heat dissipation elements 410 and the resistive element 420. Electrode layers 450 (similar to electrodes 250a, 250b or 350a, 350b) can be seen attached to a lower surface of the resistive element 420.

FIG. 5A shows a top view of a resistor 500 with partially transparent layers for illustrative purposes. The resistor 500 may have swages 509 and may have a general arrangement as described above with respect to FIGS. 2A-2H or FIGS. 3A-3B. The resistor 500 may be similar to resistor 200 or resistor 300 and therefore may also utilize the descriptions of resistor 200 or resistor 300. FIG. 5A shows a transparent top view of the resistor 500, illustrating heat dissipation elements 510 (similar to the heat dissipation elements 210a, 210b or 310a, 310b above), a resistive element 520 (similar to the resistive element 220 or 320 above) and a dielectric material 540 (similar to the dielectric material 240a, 240b or 340a, 340b above).

The resistive element 520 may be calibrated, for example, by thinning to a desired thickness or by manipulating the current path by cutting through the resistive element 520 in specific locations based, for example, on the target resistance value for the resistor 500. The patterning may be done by chemical etching and/or laser etching. The resistive element 520 may be etched such that two grooves 504 are formed under each of the heat dissipation elements 510. The dielectric material 540 may fill the grooves 504. As can be seen in FIG. 5A, the heat dissipation elements 510 may have a width that is greater than the width of the resistive element 520 by approximately 2-4%.

FIG. 5B shows a side view of the resistor 500 with partially transparent layers for illustrative purposes. A close up view 501 of an upper corner of the resistor 500 is shown where heat dissipation elements 510 may be seen covered by a solderable element 560. A swage 509 may be located at the upper and outer corner of the heat dissipation elements 510 and corresponding solderable element 560.

FIG. 5C shows a bottom view of the resistor 500 with partially transparent layers for illustrative purposes. A close up view 502 shows a detailed view of the middle portion of the resistor 500 showing the resistive element 520, the heat dissipation elements 510, and the dielectric material 540 covering external portions of the conductive elements 510 and the resistive element 520.

FIG. 5D shows an isometric view of the resistor 500 with cut away views for illustrative purposes. An adhesive material 530 (similar to adhesive material 230 or 330) formed on an upper surface of the resistive element 520 may thermally bond the heat dissipation elements 510 and the resistive element 520. Electrode layers 550 (similar to electrodes 250a, 250b or 350a, 350b) may be attached to a lower surface of the resistive element 520.

FIG. 6A shows a top view of a resistor 600 with partially transparent layers for illustrative purposes. The resistor 600 may have swages 609 and may have a general arrangement as described above with respect to FIGS. 2A-2H or FIGS. 3A-3B. The resistor 600 may be similar to resistor 200 or resistor 300 and therefore may also utilize the descriptions of resistor 200 or resistor 300. FIG. 6A shows a transparent top view of the resistor 600, illustrating heat dissipation elements 610 (similar to the heat dissipation elements 210a, 210b or 310a, 310b above), a resistive element 620 (similar to the resistive element 220 or 320 above) and a dielectric material 640 (similar to the dielectric material 240a, 240b or 340a, 340b above).

The resistive element 620 may be calibrated, for example, by thinning to a desired thickness or by manipulating the current path by cutting through the resistive element 620 in specific locations based, for example, on the target resistance value for the resistor 600. The patterning may be done by chemical and/or laser etching. The resistive element 620 may be etched such that three grooves 604 are formed under each of the heat dissipation elements 610. The dielectric material 640 may fill the grooves 604. As can be seen in FIG. 6A, the heat dissipation elements 610 may have a width that is greater than the width of the resistive element 620 by approximately 2-4%.

FIG. 6B shows a side view of the resistor 600 with partially transparent layers for illustrative purposes. A close up view 601 of an upper corner of the resistor 600 is shown where heat dissipation elements 610 may be seen covered by a solderable element 660. A swage 609 may be located at the upper and outer corner of the heat dissipation elements 610 and corresponding solderable element 660.

FIG. 6C shows a bottom view of the resistor 600 with partially transparent layers for illustrative purposes. A close up view 602 shows a detailed view of the middle portion of the resistor 600 showing the resistive element 620, the heat dissipation elements 610, and the dielectric material 640 covering external portions of the conductive elements 610 and the resistive element 620.

FIG. 6D shows an isometric view of the resistor 600 with cut away views for illustrative purposes. An adhesive material 630 (similar to adhesive material 230 or 330) formed on an upper surface of the resistive element 620 may thermally bond the heat dissipation elements 610 and the resistive element 620. Electrode layers 650 (similar to electrodes 250a, 250b or 350a, 350b) may be attached to a lower surface of the resistive element 620.

FIG. 7 is a flow diagram of an illustrative method of manufacturing any of the resistors discussed herein. For example, resistor 200 will be used to explain the example process as shown in FIG. 7. In an example method, a conductive layer or layers, which will form the heat dissipation elements, and a resistive element 220, may be cleaned and cut (705), for example, to a desired sheet size. The conductive layer or layers and the resistive element 220 may be laminated together using an adhesive material 230 (710). Electrode layers are plated to portions of the bottom surface of the resistive element 220 (715) using plating techniques as are known in the art. The conductive layer may be masked and patterned to divide the conductor into separate heat dissipation elements. In an embodiment, the resistive element may be patterned, for example using chemical etching, and/or thinned, for example using a laser, to achieve a target resistance value. A dielectric material may be deposited, coated, or applied (720) on the top and bottom of the resistor 200 to electrically isolate the plurality of conductive layers forming heat dissipation elements from each other. In an optional step, described above with reference to FIGS. 2A-2H and 3A-3B, portions of the heat dissipation elements may be compressed (725) to form swages. The force of the compression may cause the adhesive layer to compress and/or the adhesive layer and bottom portions of the heat dissipation elements to bend down towards the resistive element at the edges.

The resistive element with one or more conductive layers (heat dissipation elements) may be plated (730) with solderable layers or terminals to electrically couple the resistive element to the plurality of conductive layers (heat dissipation elements).

In any of the embodiments discussed herein, the adhesive material may be sheared during singulation, eliminating the need to remove certain adhesive materials, such as Kapton, in a secondary lasing operation to expose the resistive element before plating.

Although the features and elements of the present invention are described in the example embodiments in particular combinations, each feature may be used alone without the other features and elements of the example embodiments or in various combinations with or without other features and elements of the present invention.

1.-20. (canceled)

21. A resistor comprising:
a resistive element having an upper surface, an opposite bottom surface, a first side, and an opposite second side; and
a first heat dissipation element adjacent the first side of the resistive element, the first heat dissipation element having a bottom surface thermally coupled to the upper surface of the resistive element by an adhesive, an outer portion of the first heat dissipation element compressed in an area adjacent the first side of the resistive element, a bottom surface of the outer portion of the first heat dissipation element being bent toward the resistive element;
a second heat dissipation element adjacent the second side of the resistive element and separated by a gap from the first heat dissipation element, the second heat dissipation element having a bottom surface thermally coupled to the upper surface of the resistive element by an adhesive, an outer portion of the second heat dissipation element compressed in an area adjacent the second side of the resistive element, a bottom surface of the outer portion of the second heat dissipation element being bent toward the resistive element;
a first electrode layer positioned along the bottom surface of the resistive element, adjacent the first side of the resistive element; and
a second electrode layer positioned along the bottom surface of the resistive element, adjacent the second side of the resistive element.

22. The resistor of claim 21, further comprising:
a first solderable layer covering a first side of the resistor, the first solderable layer in contact with the first heat dissipation element, the resistive element, and the first electrode layer; and,
a second solderable layer covering a second side of the resistor, the second solderable layer in contact with the second heat dissipation element, the resistive element, and the second electrode layer.

23. The resistor of claim 22, wherein the first solderable layer covers at least a portion of an upper surface of the first heat dissipation element, and at least a portion of a bottom surface of the first electrode layer.

24. The resistor of claim 23, wherein the second solderable layer covers at least a portion of an upper surface of the second heat dissipation element, and at least a portion of a bottom surface of the second electrode layer.

25. The resistor of claim 21, wherein each of the first heat dissipation element and the second heat dissipation element has a swage at upper and outer corners of the heat dissipation elements.

26. The resistor of claim 25, wherein the swages form a step in each of the heat dissipation elements, with the outer portions of the heat dissipation elements having a first height, and inner portions of the heat dissipation elements have a second height greater than the first height.

27. The resistor of claim 21, wherein the outer portion of the bottom surface of the first heat dissipation element is positioned closer to the first electrode layer than an inner portion of the bottom surface of the first heat dissipation element, and wherein the outer portion of the bottom surface of the second heat dissipation element is positioned closer to the second electrode layer than an inner portion of the bottom surface of the second heat dissipation element.

28. The resistor of claim 21, wherein the first side of the resistive element is rounded, and wherein the second side of the resistive element is rounded.

29. The resistor of claim 21, wherein the adhesive layer is compressed in an area adjacent the first side of the resistive element, and wherein the adhesive layer is compressed in an area adjacent the second side of the resistive element.

30. The resistor of claim 29, wherein the resistive element has curved upper and outer corners adjacent areas where the adhesive layer is compressed.

31. A method of manufacturing a resistor, the method comprising:
providing a resistive element having an upper surface, a bottom surface, a first side, and an opposite second side; and
thermally coupling a first heat dissipation element to the upper surface of the resistive element adjacent the first side of the resistive element by an adhesive;
thermally coupling a second heat dissipation element to the upper surface of the resistive element adjacent the second side of the resistive element by an adhesive;
compressing an outer portion the first heat dissipation element so as to bend an outer portion of a bottom surface of the first heat dissipation toward the resistive element in an area adjacent the first side of the resistive element;
compressing an outer portion the second heat dissipation element so as to bend an outer portion of a bottom surface of the second heat dissipation toward the resistive element in an area adjacent the second side of the resistive element;
providing a first electrode layer along the bottom surface of the resistive element, adjacent the first side of the resistive element; and
providing a second electrode layer positioned along the bottom surface of the resistive element, adjacent the second side of the resistive element.

22. The method of claim 31, further comprising the steps of:
plating a first solderable layer to a first side of the resistor, the first solderable layer in contact with a heat dissipation element, the resistive element, and an electrode layer; and,
plating a second solderable layer to a second side of the resistor, the second solderable layer in contact with a heat dissipation element, the resistive element, and an electrode layer.

33. The method of claim 32, wherein the first solderable layer covers at least a portion of an upper surface of the first heat dissipation element, and at least a portion of a bottom surface of an electrode layer.

34. The method of claim 33, wherein the second solderable layer covers at least a portion of an upper surface of the second heat dissipation element, and at least a portion of a bottom surface of an electrode layer.

35. The method of claim 31, further comprising forming a swage in each of the heat dissipation elements at upper and outer corners of the heat dissipation elements.

36. The method of claim 35, wherein the swages form a step in each of the heat dissipation elements, with the outer portions of the heat dissipation elements having a first height, and inner portions of the heat dissipation elements have a second height greater than the first height.

37. The method if claim 31, further comprising positioning the outer portion of the bottom surface of the first heat dissipation element closer to the first electrode layer than an inner portion of the bottom surface of the first heat dissipation element, and positioning the outer portion of the bottom surface of the second heat dissipation element closer to the second electrode layer than an inner portion of the bottom surface of the second heat dissipation element.

38. The method of claim 31, further comprising rounding the first side of the resistive element, and rounding the second side of the resistive element.

39. The method of claim 31, further comprising compressing the adhesive layer in an area adjacent the first side of the resistive element, and compressing the adhesive layer in an area adjacent the second side of the resistive element.
